(19) United States
(12) Patent Application Publication
(10) Pub. No.: US 2020/0127505 A1
(43) Pub. Date: Apr. 23, 2020

(54) GUIDE DEVICE AND POWER SUPPLY SYSTEM

(71) Applicant: TOSHIBA TEC KABUSHIKI KAISHA, Tokyo (JP)

(72) Inventor: Masakazu Kato, Numazu Shizuoka (JP)

(21) Appl. No.: 16/532,546

(22) Filed: Aug. 6, 2019

(30) Foreign Application Priority Data
Oct. 22, 2018 (JP) 2018-198594

(51) Int. Cl. H02J 50/90; H02J 50/20; H02J 7/02; B62B 5/00

(52) U.S. Cl. CPC H02J 50/90; H02J 50/20; B62B 3/14; B62B 5/00; H02J 7/025

(57) ABSTRACT

According to one embodiment, a guide device includes a groove configured to limit a direction in which a wheel provided in a cart moves to a predetermined moving direction such that the cart is guided to the storage position. The groove has a groove width such that a slope of the direction of the wheel in the groove with respect to the moving direction is less than a predetermined value.

### CROSS-REFERENCE TO RELATED APPLICATION

This application is based upon and claims the benefit of priority from Japanese Patent Application No. 2018-198594, filed Oct. 22, 2018, the entire contents of which are incorporated herein by reference.

### FIELD

Embodiments described herein relate generally to a guide device and a power supply system.

### BACKGROUND

Recently, a power supply system that charges a battery using a technique (contactless power transmission) of transmitting power in a contactless manner is proposed. In the contactless power transmission, in order to efficiently transmit power, it is important to align a power receiving antenna such as coil and a power transmitting antenna. For example, in a system that transmits power to a power receiving coil provided in a moving object in a contactless manner, it is necessary to reliably move the moving object according to an installation position of a power transmitting coil.

As a power supply system using contactless power transmission, a power supply system that supplies power to a battery or an electronic device mounted on a shopping cart that is operated by a user is proposed. In order to operate this power supply system, it is necessary to reliably move a shopping cart on which a power receiving device is mounted to a predetermined stop position where a power transmitting antenna is installed. However, a shopping cart that is used by a general user needs to be simply movable to a predetermined stop position and to be movable from a predetermined stop position. However, there is a problem in that it is not easy to stop a shopping cart at a stop position or to move a shopping cart from a stop position with an accuracy that allows contactless power transmission.

### DESCRIPTION OF THE DRAWINGS

FIG. 1 is a perspective view illustrating a configuration example of a shopping cart on which a battery that is charged by a power supply system according to an embodiment is mounted;

FIG. 2 is perspective view illustrating a state where the shopping carts on which the battery that is charged by the power supply system is mounted are stored in a storage position;

FIG. 3 is a block diagram illustrating a configuration example of a control system of the power supply system;

FIG. 4 is a diagram illustrating an arrangement example of power transmitters in the power supply system;

FIG. 5 is a diagram illustrating a modification example of the power transmitters in the power supply system;

FIG. 6 is a diagram illustrating a relationship between a groove that is formed by a guide rail as a guide device according to the embodiment and a wheel;

FIG. 7 is a diagram illustrating a first example of a wheel angle between a width of the groove that is formed by the guide rail as the guide device and a direction of the wheel;

FIG. 8 is a diagram illustrating a second example of a wheel angle between a width of the groove that is formed by the guide rail as the guide device and a direction of the wheel;

FIG. 9 is a diagram illustrating a third example of a wheel angle between a width of the groove that is formed by the guide rail as the guide device and a direction of the wheel;

FIG. 10 is a diagram illustrating a fourth example of a wheel angle between a width of the groove that is formed by the guide rail as the guide device and a direction of the wheel;

FIG. 11 is a diagram illustrating a fifth example of a wheel angle between a width of the groove that is formed by the guide rail as the guide device and a direction of the wheel;

FIG. 12 is a diagram illustrating experiment results of a subjective evaluation relating to easiness in moving of the cart with respect to a width of the groove that is formed by the guide rail as the guide device;

FIG. 13 is a diagram illustrating a first configuration example of inner walls of the groove that is formed by the guide rail as the guide device; and

FIG. 14 is a diagram illustrating a second configuration example of the inner walls of the groove that is formed by the guide rail as the guide device.

### DETAILED DESCRIPTION

Embodiments provide a guide device that can reliably move a moving object to a predetermined position or can easily move a moving object from a predetermined position and a power supply system.

In general, according to one embodiment, a guide device includes a groove configured to limit a direction in which a wheel provided in a cart moves to a predetermined moving direction such that the cart is guided to the storage position. The groove has a groove width such that a slope of the direction of the wheel in the groove with respect to the moving direction is less than a predetermined value.

Hereinafter, a power supply system according to an embodiment will be described with reference to the drawings.

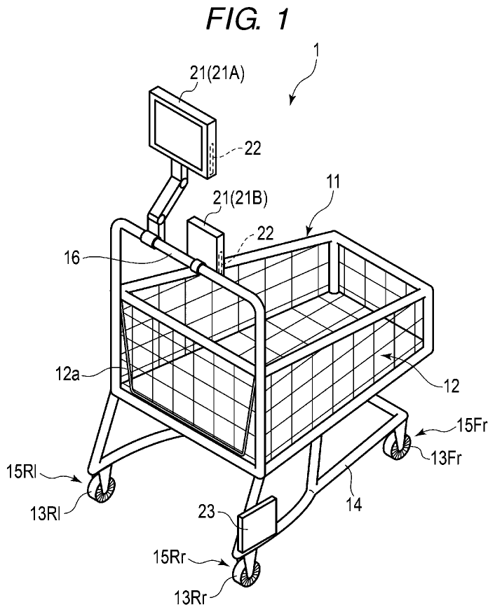

FIG. 1 is a perspective view illustrating a configuration example of a shopping cart 1 on which a battery that is charged by the power supply system according to the embodiment is mounted.

The shopping cart (hereinafter, also simply referred to as “cart”) 1 is an example of a moving object on which the battery that is charged by the power supply system is mounted. The power supply system includes: a system on a power transmitting side (power transmitting system) that transmits power in a contactless manner; and a system on a power receiving side (power receiving system) that receives power transmitted in a contactless manner.

The power receiving system is a power receiving device that is mounted on the cart 1 and receives power transmitted in a contactless manner. For example, the power receiving system charges the battery mounted on the cart 1 with power received in a contactless manner. The power transmitting system is a power transmitting device transmitting power that can be received by the power receiving system mounted on the cart 1. For example, the power transmitting system is configured to transmit power in a contactless manner to the power receiving system mounted on the cart 1 that is stored in a storage position (cart bay).

In addition, the battery that is charged by the power supply system mounted on the cart 1 is a power supply device that supplies power to an electronic device mounted on the cart 1. The battery that is charged by the power supply system may be included in the electronic device mounted on the cart 1. In addition, the battery that is charged by the power supply system may be mounted on the cart 1 as a separate device from the electronic device to supply power to the electronic device.

In the configuration example illustrated in FIG. 1, the cart 1 is configured by attaching an electronic device 21 and a power receiver 23 to a cart main body 11 that is movable in a state where it stores commodities, the electronic device 21 including a battery 22. The cart main body 11 is configured to be movable by a user in a state where it stores commodities. The electronic device 21 is a device that provides information or a service to the user. The battery 22 is a power supply device for operating the electronic device 21. The power receiver 23 receives power transmitted from an external apparatus. The electronic device 21 charges the battery 22 with power received by the power receiver 23.

The battery 22 may be configured as a power supply device (external power supply) that is separately provided from the electronic device 21. The battery 22 as an external power supply is configured to include: a charging circuit that charges a secondary battery with power from the power receiver 23; and a secondary battery that stores power. In this case, the battery 22 may be configured to supply power stored in the secondary battery to the electronic device 21.

The cart main body 11 includes a storage basket 12 that stores commodities. The storage basket 12 is supported by a frame 14 provided with four casters 15 (15Fr 15Fl, 15Rr, 15Rl). The four casters 15 are provided at lower corners of the frame 14, respectively. The casters 15 (15Fr 15Fl, 15Rr, 15Rl) include wheels 13 (13Fr, 13Fl, 13Rr, 13Rl) that rotate in a moving direction, respectively. The cart main body 11 moves by the wheel 13 of each of the casters 15 rotating on a floor. In addition, each of the casters 15 is configured such that the rotation direction of the wheel 13 freely rotates. As a result, the moving direction of the cart main body 11 can be freely changed.

A handle 16 is provided on one surface side of the storage basket 12 in the frame 14. The handle 16 is held by the user. For example, the user holds the handle 16 to move the cart main body 11. In the embodiment, a direction in which the user presses the storage basket 12 from the handle 16 held by the user is set as “advancing direction”. With respect to the advancing direction, the wheel 13Fr that is supported by the caster 15Fr is set as a right front wheel, and the wheel 13Fl that is supported by the caster 15Fl is set as a left front wheel. In addition, the wheel 13Rr that is supported by the caster 15Rr is set as a right rear wheel, and the wheel 13Rl that is supported by the caster 15Rl is set as a left rear wheel.

In addition, the lower portion of the frame 14 provided with the four casters 15 at the four corners is formed such that the front side in the advancing direction is narrow and the rear side in the advancing direction is wide. Therefore, the casters 15Fr and 15Fl that support the front wheels have narrower widths in the left-right direction than the casters 15Rr and 15Rl that support the rear wheels. As a result, when a plurality of carts are stored to be aligned in the front-rear direction, the carts are stored such that the frame of a rear cart overlaps the frame of a front cart.

In addition, in the embodiment, the handle 16 side with respect to the storage basket 12 will be referred to as “proximal side”, and the side opposite to the proximal side will be referred to as “distal side”. The storage basket 12 includes an opening-and-closing surface 12a as a proximal side surface that is openable and closable with a lower end as a free end. In addition, the storage basket 12 is formed such that a distal side surface is smaller than the proximal side surface that is the opening-and-closing surface 12a. As a result, when the carts are stored to be aligned in the front-rear direction, a rear cart presses up the opening-and-closing surface 12a of a front cart such that the storage baskets 12 of the front and rear carts overlap each other.

The electronic device 21 is attached to the cart main body 11. In the configuration example illustrated in FIG. 1, the electronic device 21 includes the battery 22 and is attached to the handle 16 of the storage basket 12. The electronic device 21 is driven by power from the battery 22. For example, the electronic device 21 is an information terminal such as a tablet terminal for providing information to the user or is a commodity reader that acquires information of a commodity selected by the user. In addition, the electronic device 21 may be, for example, a charging device for charging an electronic device of a mobile terminal (for example, a mobile phone, a smartphone, or a digital camera) carried by the user with power from the battery 22.

In the configuration example illustrated in FIG. 1, a tablet terminal 21A and a commodity reader 21B are used as the electronic device 21. The tablet terminal 21A is a computer including a display unit provided with a touch panel. The tablet terminal 21A is provided such that the display unit faces the user positioned on the handle 14 side. For example, the tablet terminal 21A displays information of a commodity read by the commodity reader. In addition, the tablet terminal 21A may execute a checkout process on a commodity read by the commodity reader.

The commodity reader 21B as the electronic device 21 is a device that reads information of a commodity. The commodity reader 21B may include a display unit that displays the read information of the commodity. For example, the commodity reader 21B is a RFID tag reader that reads a RFID tag or the like attached to a commodity that is put into or out from the storage basket 12. In addition, the commodity reader 21B may be a scanner that reads commodity identification information such as a barcode attached to a commodity.

As the electronic device 21, an interface device for connection to a mobile terminal (for example, a smartphone or a tablet terminal) carried by the user instead of the tablet terminal 21A may be provided. The mobile terminal connected to the interface device as the electronic device 21 may execute the same process as the tablet terminal 21A does. In addition, the interface device as the electronic device 21 may charge the battery included in the mobile terminal. The interface device as the electronic device 21 may be embedded in the battery 22 or may be connected to the battery 22 that is separately provided.

The power receiver 23 is attached to a side surface of the cart main body 11. The power receiver 23 receives power transmitted in a contactless manner or supplies the received power to the electronic device 21 or the battery 22. The power receiver 23 includes a power receiving antenna and a circuit. The power receiver 23 is provided on a side surface of the cart main body 11 such that a power receiving surface (surface facing an antenna on a side where power is received) on which the power receiving antenna receives power is substantially perpendicular to the floor. A configuration of a control system of the power receiver 23 will be described below in detail.

The power receiver 23 is provided on the side surface of the cart main body 11 so as to receive power transmitted from a lateral side of the cart main body 11. In the configuration example illustrated in FIG. 1, in a state where the power receiving surface of the power receiving antenna is substantially perpendicular to the floor, the power receiver 23 is provided above the caster 15Rr that supports the rear wheel 13Rr toward the outer side of the cart main body 11. In the configuration illustrated in FIG. 1, the power receiver 23 can receive power output from a power transmitting antenna that is provided on the right side of the cart main body 11. The power receiver 23 may be arranged on the side surface of the cart main body 11 in a state where the power receiving surface of the power receiving antenna is substantially perpendicular to the floor. A position where the power receiver 23 is provided may be set according to the arrangement of a power transmitter 32 including the power transmitting antenna that is provided to face the power receiving antenna.

Next, a configuration of the power supply system for charging the battery 22 mounted on the cart 1 having the above-described configuration will be described.

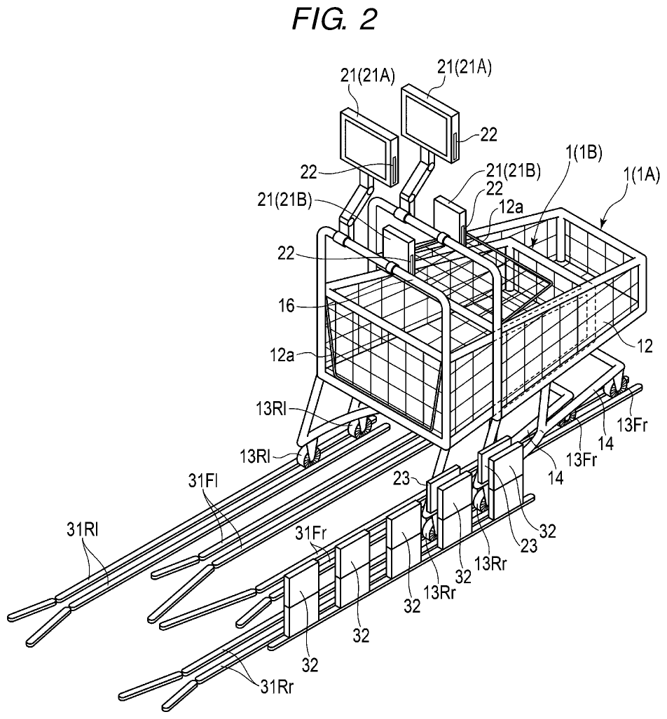

FIG. 2 is perspective view illustrating a state where the carts 1 on which the battery 22 that is charged by the power supply system according to the embodiment is mounted are stored in the storage position.

Each of the carts 1 on which the battery 22 is mounted is stored in a predetermined storage position (cart bay) as illustrated in FIG. 2. FIG. 2 illustrates a state where two carts 1 (1A and 1B) are stored in the storage position. However, it is assumed that the carts 1 are stored to be aligned in the storage position.

In the storage position, four guide rails 31 (31Rr, 31Rl, 31Fr, 31Fl) for guiding the respective wheels 13 of the four casters 15 in each of the carts 1 to be stored are provided. The guide rails 31 are guide devices for guiding each of the carts 1 to a predetermined position in the storage position. In the example illustrated in FIG. 2, the pair of guide rails 31Rr and 31Rl corresponding to the rear wheels of the cart 1 and the pair of guide rails 31Fr and 31Fl corresponding to the front wheels of the cart 1 are provided. The guide rails 31 are not particularly limited as long as they guide each of the carts 1 to a predetermined position in the storage position, and are not limited to the configuration where four guide rails are arranged. For example, in the configuration of the guide rail 31, among the four guide rails 31Rr, 31Rl, 31Fr, and 31Fl, one or two guide rails are not necessarily provided.

In a state where front and rear carts overlap each other, the respective carts 1 are stored in the storage position by the wheels moving along the guide rails 31. The proximal side surface of the storage basket 12 in the cart 1 is the opening-and-closing surface 12a that is openable and closable with a lower end as a free end. In addition, the storage basket 12 is formed such that the distal side surface is smaller than the proximal side surface that is the opening-and-closing surface 12a. As a result, when the distal side of the storage basket 12 of the rear cart 1B is pressed against the opening-and-closing surface 12a of the front cart 1A, the opening-and-closing surface 12a of the front cart is pressed up. When the rear cart 1B is pressed in a state where the opening-and-closing surface 12a of the front cart 1A is pressed up, the storage basket 12 of the cart 1B is stored to overlap the storage basket 12 of the cart 1A.

In addition, the frame 14 of each of the carts 1 is formed such that the proximal side is wide and the distal side is narrow in a left-right direction with respect to the moving direction along the guide rails 31. Therefore, the casters 15Fr and 15Fl that support the front wheels 13Fr and 13Fl of the cart 1 have narrower widths in the left-right direction than the casters 15Rr and 15Rl that support the rear wheels 13Rr and 13Rl. As a result, when the carts are stored to be aligned in the front-rear direction, the carts are stored such that the frame 14 of the rear cart 1B overlaps the frame 14 of the front cart 1A.

As described above, the carts 1 (1A and 1B) are stored in the storage position in a state where the front and rear carts overlap each other. The wheels of each of the carts 1 move along the guide rails 31 in the storage position. Therefore, the overlapping state is determined according to a shape of the frame 14 and the storage basket 12. When a front-rear interval of the respective carts 1 that are stored in the storage position to overlap each other is a predetermined distance, an interval at which the power receivers 23 of the respective carts 1 are arranged is also a predetermined distance. That is, in the storage position, the respective carts 1 move along the guide rails 31 and are stored in a state where the front and rear carts 1 overlap each other. Therefore, in the storage position, the power receivers 23 of the respective carts 1 are arranged at a predetermined interval corresponding to the front-rear interval of the respective carts 1 in the stored state.

The power transmitter 32 outputs power that can be received by the power receiver 23 in a contactless manner. The power transmitter 32 includes an antenna for power transmission and a circuit for power transmission. The power transmitter 32 is provided toward the side surface of the cart main body 11 such that a power transmitting surface (surface facing the power receiving antenna of the power receiver) on which the antenna for power transmission (power transmitting antenna) outputs power is substantially perpendicular to the floor. A configuration of a control system of the power transmitter 32 will be described below in detail.

In addition, the power transmitter 32 is provided at a position facing the power receiver 23 of each of the carts 1 stored in the storage position. In the configuration example illustrated in FIG. 2, the power receivers 23 of the respective carts 1 stored in the storage position are arranged along the guide rails 31 at a predetermined interval. Therefore, the power transmitters 32 are arranged along the guide rails 31 at a predetermined interval so as to face the power receivers 23 of the respective stored carts 1.

Next, a configuration of a control system of the power supply system will be described.

The power supply system includes: a power receiving system including the power receiver 23 that is provided in each of the carts 1; and a power transmitting system including the power transmitter 32 that is provided corresponding to the position of the cart 1 in the storage position. That is, the power supply system is a system in which the power transmitter 32 provided corresponding to the position of the cart in the storage position transmits power to the power receiver 23 provided at each of the carts in a contactless manner. In the power supply system, the power transmitter 32 of the power transmitting system transmits power in a state (contactless state) where the power transmitter 32 is not physically and electrically connected to the power receiver 23 of the power receiving system.

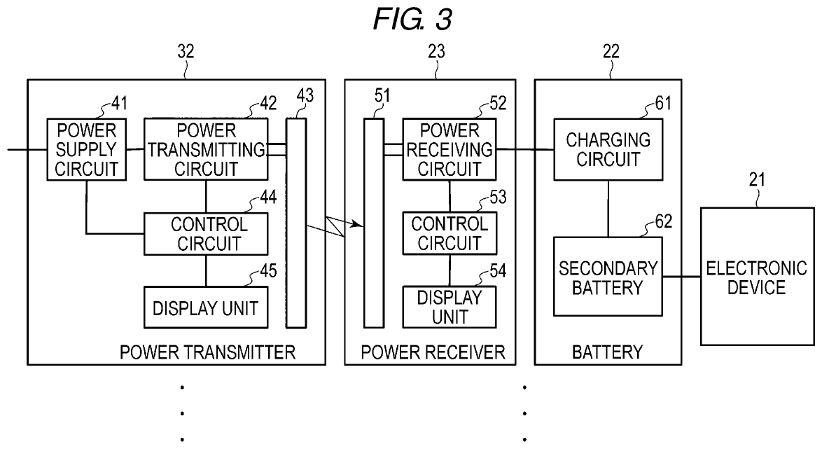

FIG. 3 is a block diagram illustrating a configuration example of the control system of the power supply system.

The power supply system is a system that transmits power in a contactless manner and includes a system on a power transmitting side (power transmitting system) and a system on a power receiving side (power receiving system). The power transmitting system is a system for transmitting power to the power receiver 23 mounted on each of the carts 1 in a contactless manner, the carts 1 being stored in the storage position. The power receiving system is a system for receiving power using the power receiver 23 in a contactless manner and charging the battery 22 with the received power.

The power transmitting system includes the power transmitters 32 that are provided along the guide rails 31 in the storage position. Each of the power transmitters 32 supplies direct current power through a direct current power supply such as an AC adapter connected to a commercial power supply. The power transmitter 32 operates either in a power transmitting state of supplying power to the power receiver 23 or in a stand-by state of not supplying power to the power receiver 23.

In the configuration illustrated in FIG. 3, each of the power transmitters 32 constituting the power transmitting system includes a power supply circuit 41, a power transmitting circuit 42, a power transmitting coil 43, a control circuit 44, and a display unit 45.

The power supply circuit 41 converts a voltage of direct current power supply from an external device into a voltage suitable for an operation of each of the circuits. The power supply circuit 41 generates a voltage for allowing the power transmitting circuit 42 to receive power and supplies the generated power to the power transmitting circuit 42. In addition, the power supply circuit 41 generates power for operating the control circuit 44 and supplies the generated power to the control circuit 44.

The power transmitting circuit 42 generates power transmission power for transmitting power from a power transmitting antenna 43. The power transmitting circuit 42 supplies the generated power transmission power to the power transmitting antenna 43. For example, the power transmitting circuit 42 generates alternating current power as the power transmission power by switching the direct current power supplied from the power supply circuit 41 in accordance with the control of the control circuit 44.

The power transmitting antenna 43 outputs power that can be received by the power receiver 23 according to the power transmission power supplied from the power transmitting circuit 42. The power transmitting antenna 43 is formed such that the power transmitting surface on which power is transmitted is formed flat. The power transmitting surface of the power transmitting antenna 43 is arranged to face the power receiving surface of a power receiving antenna 51 of the power receiver 23 in a state where the power transmitting surface is substantially perpendicular to the floor.

For example, the power transmitting antenna 43 configures a resonance circuit (power transmitting resonance circuit) by a coil for power transmission (power transmitting coil) being connected in series or in parallel to a capacitor for resonance. When alternating current power is supplied from the power transmitting circuit 42, the power transmitting antenna 43 as the power transmitting resonance circuit generates a magnetic field corresponding to the supplied alternating current power. The power transmitting coil of the power transmitting antenna 43 may be configured as a winding structure in which an insulated electric wire is wound, or may be configured by a coil pattern being formed on a printed circuit board.

The display unit 45 is an indicator indicating the state of the power transmitter 32. The display unit 45 switches between displays in accordance with the control of the control circuit 44. For example, the display unit 45 switches between display colors according to the operation state of the power transmitter 32. In addition, the display unit 45 may display the operation state with a message.

The control circuit 44 controls operations of the power transmitting circuit 42 and the display unit 45. The control circuit 44 includes a processor and a memory. The processor executes arithmetic processing. For example, the processor executes various processes based on a program stored in the memory and data used in the program. The memory stores the program and the data used in the program. The control circuit 44 may be configured with a microcomputer and/or an oscillation circuit.

For example, the control circuit 44 switches between displays of the display unit 45 according to the state of the power transmitter 32. In addition, the control circuit 44 controls a frequency of alternating current power that is output from the power transmitting circuit 42 and controls whether or not to turn on or off the operation of the power transmitting circuit 42. For example, the control circuit 44 controls the power transmitting circuit 42 to switch between the state (power transmitting state) where the power transmitting coil of the power transmitting antenna 43 is caused to generate a magnetic field and the state (stand-by state) where the power transmitting coil is not caused to generate a magnetic field. In addition, the control circuit 44 may cause the power transmitting coil of the power transmitting antenna 43 to intermittently generate a magnetic field such that power to be transmitted is changed.

In each of the power transmitters 32, a wireless communication circuit for wireless communication may be provided. For example, the wireless communication circuit is a circuit that executes wireless communication at a frequency different from that of power transmission. The control circuit 44 may control each of the units by executing wireless communication with the power receiver 23 through the wireless communication circuit. In addition, using load modulation, the wireless communication circuit may execute wireless communication at the same frequency as the frequency of power transmission.

Next, the power receiving system will be described.

The power receiving system is a system including the power receiver 23 and the battery 22 mounted on each of the carts 1. The power receiver 23 includes the power receiving antenna 51, a power receiving circuit 52, a control circuit 53, and a display unit 54. In addition, the battery 22 includes a charging circuit 61 and a secondary battery 62. The power receiver 23 may be configured to include an output terminal through which power is supplied to the electronic device 21. In this case, the battery 22 may be configured to be charged by power supplied through the electronic device 21.

The power receiving antenna 51 receives power transmission power from the power transmitting antenna 43 and supplies the received power to the power receiving circuit 52. The power receiving antenna 51 is formed such that the power receiving surface on which power is received is formed flat. The power receiving surface of the power receiving antenna 51 is provided on the side surface of the cart main body 11 in a state where the power receiving surface is substantially perpendicular to the floor.

For example, the power receiving antenna 51 configures a resonance circuit (power receiving resonance circuit) by a coil for power reception (power receiving coil) being connected in series or in parallel to a capacitor. When the power receiving antenna 51 as the power receiving resonance circuit approaches the power transmitting antenna 43 of the power transmitter 32, the power receiving coil is electromagnetically coupled with the power transmitting coil of the power transmitting antenna 43. The power receiving coil of the power receiving antenna 51 generates an induced current using the magnetic field output from the power transmitting coil of the power transmitting antenna 43 of the power transmitter 32. The power receiving coil may be configured as a winding structure in which an insulated electric wire is wound, or may be configured by a coil pattern being formed on a printed circuit board.

The power receiving antenna 51 as the power receiving resonance circuit supplies the received alternating current power to the power receiving circuit 52. In other words, the power receiving antenna 51 functions as an alternating current power supply while receiving alternating current power from the power transmitter 32. In addition, when a magnetic field resonance method is used for power transmission, a self resonance frequency of the power receiving resonance circuit as the power receiving antenna 51 is configured to be substantially the same as a frequency at which the power transmitter 32 transmits power. As a result, when the power receiving coil of the power receiving antenna 51 and the power transmitting coil of the power transmitting antenna 43 are electromagnetically coupled with each other, the power transmission efficiency is improved.

The power receiving circuit 52 converts the power reception power supplied from the power receiving antenna 51 into power that can be supplied to the battery 22 or the electronic device 21. For example, the power receiving circuit 52 rectifies the power reception power supplied from the power receiving antenna 51 and converts the rectified power into direct current. The power receiving circuit 52 is implemented by, for example, a circuit including a rectifier bridge that is configured with a plurality of diodes. In this case, a pair of input terminals of the rectifier bridge are connected to the power receiving resonance circuit as the power receiving antenna 51. The power receiving circuit 52 rectifies the full wave of the power reception power supplied from the power receiving antenna 51 such that direct current power is output from the pair of output terminals.

The display unit 54 is a display device that displays various information. For example, the display unit 54 is an indicator indicating the state of the power receiver 23. The display unit 54 switches between displays in accordance with the control of the control circuit 53. For example, the display unit 54 switches between display colors according to the operation state of the power receiver 23. In addition, the display unit 54 may display the operation state with a message.

The control circuit 53 controls operations of the power receiving circuit 52 and the display unit 54. The control circuit 53 includes a processor and a memory. The processor executes arithmetic processing. For example, the processor executes various processes based on a program stored in the memory and data used in the program. The memory stores the program and the data used in the program. The control circuit 53 may be configured with a microcomputer and/or an oscillation circuit. For example, the control circuit 53 switches between displays of the display unit 54 according to the state of the power receiver 23.

The power receiver 23 may be provided with a wireless communication circuit for executing wireless communication with the corresponding power transmitter 32. For example, the wireless communication circuit is a circuit that executes wireless communication at a frequency different from that of power transmission. The control circuit 53 may control each of the units by executing wireless communication with the power transmitter 32 through the wireless communication circuit. In addition, using load modulation, the wireless communication circuit may execute wireless communication at the same frequency as the frequency of power transmission.

The charging circuit 61 supplies the power supplied from the power receiving circuit 52 of the power receiver 23 to the secondary battery 62 as power for charging (charging power). For example, the charging circuit 61 converts the power supplied from the power receiving circuit 52 into direct current (charging power) used for charging the secondary battery 62. That is, the charging circuit 61 converts the power output from the power receiving circuit 52 into charging power having a predetermined current value and a predetermined voltage value for charging the secondary battery 62 and supplies the converted charging power to the secondary battery 62.

The secondary battery 62 is charged with the charging power supplied from the charging circuit 61. In addition, the secondary battery 62 is connected to the electronic device 21 and supplies power to the electronic device 21.

Next, a position relationship between the power receiver 23 provided in each of the carts 1 and the power transmitter 32 that transmits power to the power receiver 23 will be described.

In order to transmit power between the power transmitter 32 and the power receiver 23 in a contactless manner, it is necessary to align the power transmitting antenna and the power receiving antenna. In the contactless power transmission, as the accuracy of the alignment between the power transmitting antenna and the power receiving antenna increases, the power transmission efficiency increases. For example, the power transmitting antenna (power transmitting coil) transmits power to the power receiving antenna (power receiving coil) in a contactless manner using magnetic field coupling such as electromagnetic induction or magnetic field resonance (resonance). In the contactless power transmission using the magnetic field coupling, power cannot be transmitted unless the position of the power transmitting coil and the position of the power receiving coil match each other.

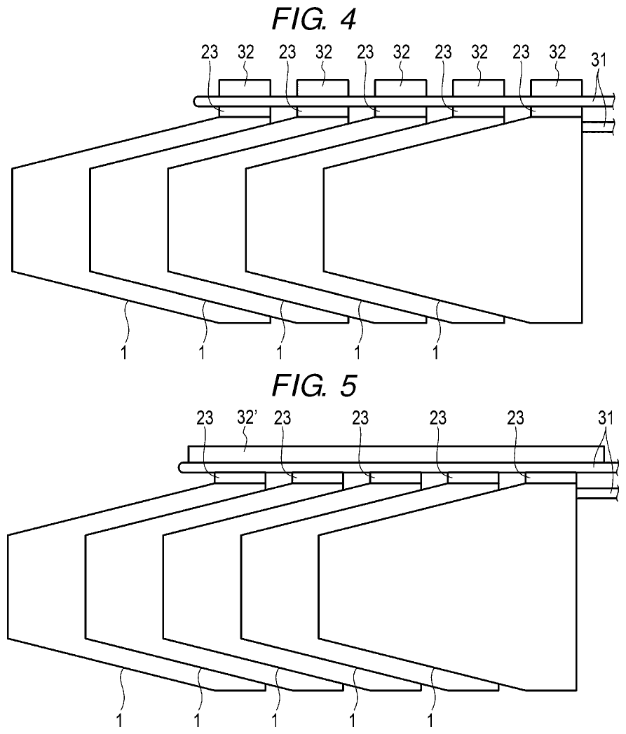

FIG. 4 is an example of a top view illustrating the respective carts 1 stored in the storage position and the power transmitters 32 provided to face the power receivers 23 of the respective carts 1 when seen from the top.

The power supply system according to the embodiment is configured such that the power transmitter 32 transmits power to the power receiver 23 provided in the cart 1 stored in the storage position. Therefore, the power transmitter 32 is arranged at a position corresponding to the position of the cart 1 (the position of the power receiver 23 provided on the side surface of the cart 1) stored in the storage position. FIG. 4 illustrates the positions of the power receivers 23 that are provided on the side surface of the respective carts 1 stored in the storage position and the power transmitters 32 that are arranged at the positions facing the power receivers 23 of the respective carts.

The cart 1 is stored in the storage position to overlap the cart that is previously stored. When the position of the cart 1 that is initially stored in the storage position is fixed, the power receivers 23 are arranged at an interval corresponding to the front-rear interval of the respective carts 1 stored in the storage position. Accordingly, the power transmitters 32 are arranged on the lateral side of the respective carts at an interval corresponding to the front-rear interval of the respective carts 1 stored in the storage position. AS a result, the power transmitters 32 can transmit power to the side surfaces of the respective carts 1 from the positions facing the power receivers 23 of the carts 1 stored in the storage position.

In addition, in the configuration example illustrated in FIG. 2, the guide rails 31 for limiting the moving direction of each of the carts 1 in the storage position are provided. In this case, the cart 1 moves along the guide rails 31 and is stored to overlap the cart that is previously stored. In the configuration where the guide rails 31 are provided in the storage position, the power transmitters 32 may be arranged at a predetermined interval along the guide rails 31 so as to be arranged on the lateral side of the carts.

The power transmitting system only has to be able to transmit power to the power receivers 23 of the carts 1 stored in the storage position.

FIG. 5 illustrates a modification example of a power transmitter 32′ in the power supply system.

In the modification example illustrated in FIG. 5, the single power transmitter 32′ that transmits power to a region including positions facing all the power receivers 23 of the carts stored in the storage position is provided. In the storage position, the carts 1 are aligned in the front-rear direction along the guide rails 31 and are stored. Therefore, the power transmitter 32′ is provided in a state where a belt-shaped power transmitting surface is substantially perpendicular to the floor such that power can be transmitted to each of the power receivers 23 of the carts that can be stored in the storage position. In this case, as illustrated in FIG. 5, the power transmitter 32′ may be arranged along the guide rails 31 in a state where the belt-shaped power transmitting surface faces the side surfaces of each of the carts 1.

As described above, in the embodiment, in each of the carts on which the battery is mounted, the power receiving antenna is provided on the side surface of respective the cart main body such that the power receiving surface is substantially perpendicular to the floor. In addition, at the position facing the power receiving antenna of each of the carts stored in the storage position, the power transmitter is provided such that the power transmitting surface of the power transmitting antenna is substantially perpendicular to the floor. With the above-described configuration, foreign matter is prevented from being placed on the power transmitting surface of the power transmitting antenna, and the possibility that foreign matter is inserted between the power receiving antenna and the power transmitting antenna is reduced. As a result, heat generation caused by foreign matter does not occur, and the power supply system that can safely transmit power in a contactless manner can be realized.

Next, a relationship between the guide rails 31 and the wheels 13 of the cart 1 will be described.

The guide rails 31 limit the moving direction of the cart 1 such that the power transmitting surface of the power transmitting antenna and the power receiving surface of the power receiving antenna approach each other. In the contactless power transmission using magnetic field coupling, in order to execute good power transmission, a range where the coil of the power transmitting antenna and the coil of the power receiving antenna need to approach each other is determined depending on the size of the coils. For example, when the coil of the power transmitting antenna and the coil of the power receiving antenna are about 10 square centimeters, in order to execute good power transmission, it is necessary that the distance between the coil of the power transmitting antenna and the coil of the power receiving antenna is about 10 mm or more and less than 20 mm. In the power supply system according to the embodiment, the power transmitting antenna of the power transmitter 32 is arranged on the lateral side of the cart 1 stored in the storage position to face the power receiving antenna provided on the side surface of the cart 1. Accordingly, the guide rails 31 limit the movement of the cart 1 such that the distance from the power receiving antenna of the power receiver 23 to the power transmitting antenna of the power transmitter 32 is about 10 mm or more and less than 20 mm.

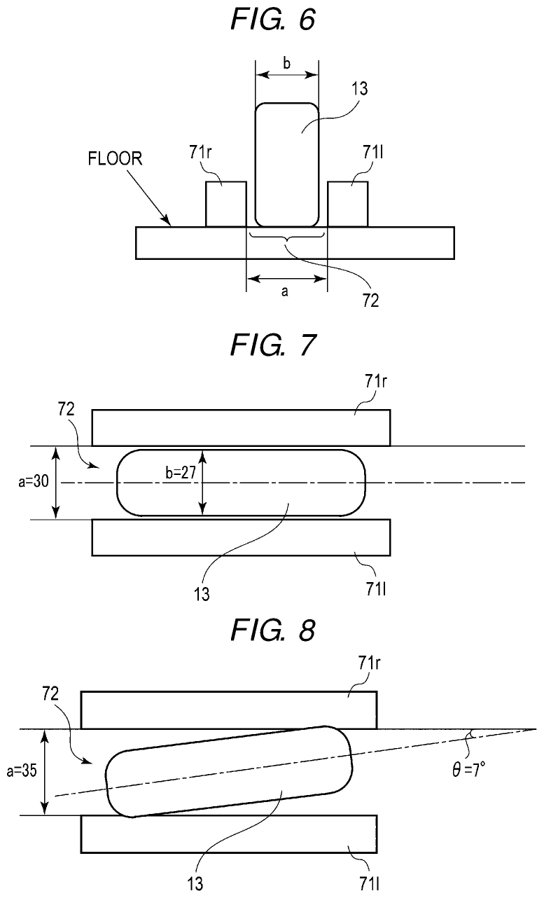

FIG. 6 is a diagram illustrating a relationship between the guide rail 31 and the wheel 13 of the cart 1.

As illustrated in FIG. 6, the guide rail 31 includes a groove 72 that is formed by a pair of rails 71 (71r and 71l). The rail 71r and the rail 71l are arranged in parallel to form the linear groove 72. The wheel 13 moves along the linear groove 72 that is formed by the rail 71r and the rail 71l. That is, the guide rail 31 is a guide for moving the wheel 13 in a predetermined moving direction using the groove 72 that is provided in the predetermined moving direction. As a result, the moving direction of the wheel 13 is limited by the groove 72 of the guide rail 31 such that the moving direction of the cart main body 11 is limited. The groove 72 may be formed by digging down the floor. In this case, inner surfaces of the groove 72 corresponds to surfaces (inner walls) of the rail 71r and the rail 71l facing each other.

As illustrated in FIG. 6, a width (groove width) a of the groove 72 is the distance between the surfaces (inner walls) of the rail 71r and the rail 71l facing each other. In addition, a width (wheel width) b of the wheel 13 is the width in a direction perpendicular to a rotation direction of the wheel 13. The guide rail 31 is formed such that the groove width a is more than the wheel width b to enable the wheel 13 to be movable in the groove 72. As the groove width a increases with respect to the wheel width b, a variation in the position of the wheel 13 in the groove 72 is large. Therefore, the groove width a is set such that the wheel 13 is movable in a range where the distance between the power receiving antenna 51 of the power receiver 23 and the power transmitting antenna 43 of the power transmitter 32 allows contactless power transmission. That is, the groove width a is more than the wheel width b and is set such that the variation in the position of the wheel 13 is in a range where contactless power transmission is possible.

In addition, the wheel 13 is supported by the caster 15 such that the direction (direction in which the wheel moves by rotating) is freely rotatable. For example, the direction of the wheel 13 changes depending on a force that is applied to the cart main body 11 by a person who holds the handle 16. A range where the direction of the wheel 13 changes in the groove 72 is determined depending on a difference between the wheel width b and the groove width a. That is, as the difference between the wheel width b and the groove width a increases, a slope of the direction of the wheel 13 that freely rotates with respect to the direction of the groove 72 (the predetermined moving direction) may increase. Here, the maximum value of the slope of the wheel 13 with respect to the predetermined moving direction (the inner wall surfaces of the respective rails 71r and 71l) in which the groove 72 is formed will be referred to as “wheel angle θ”.

As the wheel angle θ increases, the slope of the direction of the wheel 13 in the groove 72 increases, and it becomes difficult to move the cart main body 11 in the predetermined moving direction. It is assumed that the shopping cart 1 is operated by an unspecified user to be stored in the storage position or to be withdrawn from the storage position. Therefore, the guide rail 31 forms the groove 72 such that contactless power transmission between the power receiver 23 and the power transmitter 32 is possible and the user can easily move the cart 1.

FIGS. 7 to 11 are diagrams illustrating a relationship between the groove width a and the wheel angle θ. In FIGS. 7 to 11, the wheel width b is 27 mm.

FIG. 7 illustrates a state where the wheel 13 rotates in the groove 72 when the groove width a of the guide rail 31 is 30 mm. When the wheel width b is 27 mm and the groove width a is 30 mm (when the groove width a is about 1.1 time the wheel width b), the wheel angle θ is less than 3 degrees. In this case, the wheel 13 that moves along the groove 72 moves substantially parallel to the predetermined moving direction. As a result, the cart main body 11 can be reliably moved in the predetermined moving direction.

On the other hand, when the wheel width b is 27 mm and the groove width a is 30 mm, the difference between the wheel width b and the groove width a is 3 mm. In this case, when the cart 1 is moved, the side surface of the wheel 13 with respect to the rotation direction and the inner wall of the rail 71r or 71l are likely to rub with each other, and the friction increases. In a case where the friction between the side surface of the wheel 13 and the inner wall of the rail 71r or 71l increases, when the user moves the cart 1, the resistance increases.

Accordingly, when the wheel angle θ is less than 3 degrees, the cart 1 can be reliably moved in the predetermined moving direction, but the resistance is large due to the friction during moving. As a result, it is presumed that the user feels that it is difficult to move the cart 1 along the guide rail 31.

FIG. 8 illustrates a state where the wheel 13 having a wheel width b of 27 mm rotates in the groove 72 when the groove width a of the guide rail 31 is 35 mm.

When the wheel width b is 27 mm and the groove width a is 35 mm (when the groove width a is about 1.3 time the wheel width b), the wheel angle θ is about 7 degrees. In this case, when the maximum slope of the wheel 13 that moves along the groove 72 is about 7 degrees, the wheel 13 collides with the inner wall of the rail 71r or 71l and moves along the predetermined moving direction while the direction is being corrected. It is presumed that, in a case where the maximum slope is about 7 degrees, the direction can be easily corrected even when the wheel 13 collides with the inner wall of the rail 71r or 71l.

On the other hand, when the wheel width b is 27 mm and the groove width a is 35 mm, the difference between the wheel width b and the groove width a is 8 mm. In this case, the wheel 13 moves while colliding with the inner wall of the rail 71r or 71l. However, it is presumed that the friction between the side surface of the wheel 13 and the inner wall of the rail 71r or 71l is not large.

Accordingly, when the wheel angle θ is about 7 degrees, the cart 1 can move along the predetermined moving direction while the wheel 13 is smoothly rotating. As a result, it is presumed that the user feels that it is easy to move the cart main body 11 in the moving direction.

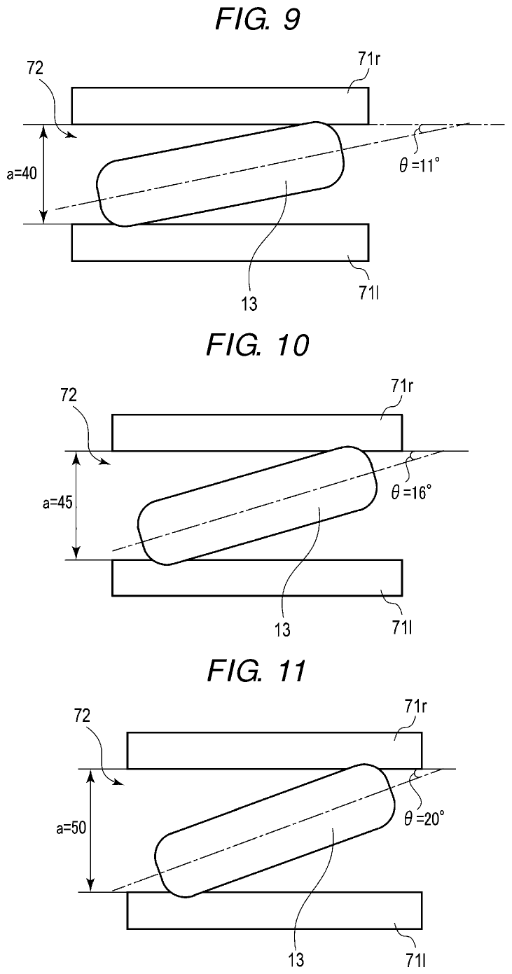

FIG. 9 illustrates a state where the wheel 13 having a wheel width b of 27 mm rotates in the groove 72 when the groove width a of the guide rail 31 is 40 mm.

When the wheel width b is 27 mm and the groove width a is 40 mm (when the groove width a is about 1.5 time the wheel width b), the wheel angle θ is about 11 degrees. In this case, the maximum slope of the wheel 13 that moves along the groove 72 is about 11 degrees, and the wheel 13 collides with the inner wall of the rail 71r or 71l such that the direction is corrected. However, in order to collect the direction of the wheel 13 that collides with the inner wall of the rail 71r or 71l at a slope of about 11 degrees, it is presumed that the cart main body 11 needs to be operated with a strong force.

On the other hand, when the wheel width b is 27 mm and the groove width a is 40 mm, the difference between the wheel width b and the groove width a is 13 mm. In this case, it is presumed that the friction between the side surface of the wheel 13 and the rail 71r or 71l is not large.

Accordingly, it is presumed that, when the wheel angle θ is about 11 degrees, the wheel 13 itself can smoothly rotate, but a force is required to move the cart main body 11 in the predetermined moving direction. As a result, it is presumed that the user feels that it is slightly difficult to move the cart 1 in the moving direction.

FIG. 10 illustrates a state where the wheel 13 having a wheel width b of 27 mm rotates in the groove 72 when the groove width a of the guide rail 31 is 45 mm.

When the wheel width b is 27 mm and the groove width a is 45 mm (when the groove width a is about 1.7 time the wheel width b), the wheel angle is about 16 degrees. In this case, the maximum slope of the wheel 13 that moves along the groove 72 is about 16 degrees. In this case, when the angle at which the wheel 13 collides with the inner wall of the rail 71r or 71l is large, it is difficult to correct the direction of the wheel 13 to the moving direction. For example, in a case where the cart 11 is withdrawn from the storage position, when it is difficult to change the direction of the wheel 13 in the groove 72, the user cannot simply use the cart 1.

Accordingly, when the wheel angle θ is about 16 degrees, it is difficult to change the direction of the wheel 13 in the groove 72, and it is difficult to move the cart main body 11 in the predetermined moving direction. As a result, it is presumed that the user may feel that it is difficult to move the cart 1 in the moving direction.

FIG. 11 illustrates a state where the wheel 13 having a wheel width b of 27 mm rotates in the groove 72 when the groove width a of the guide rail 31 is 50 mm.

When the wheel width b is 27 mm and the groove width a is 50 mm (when the groove width a is about 1.9 time the wheel width b), the wheel angle θ is about 20 degrees. In this case, the maximum slope of the wheel 13 that moves along the groove 72 is about 20 degrees. In this case, when the wheel 13 collides with the inner wall of the rail 71r or 71l, it is difficult to change the direction of the wheel 13. In addition, in this case, it is presumed that, when the user operates the cart main body 11 with a strong force, the wheel 13 may run on the rail 71r or 71l.

Accordingly, when the wheel angle θ is about 20 degrees, it is difficult to change the direction of the wheel 13 in the groove 72, and the wheel 13 may come off from the guide rail 31. As a result, it is presumed that it is difficult to adopt a wheel angle of about 20 degrees or more in the power supply system according to the embodiment.

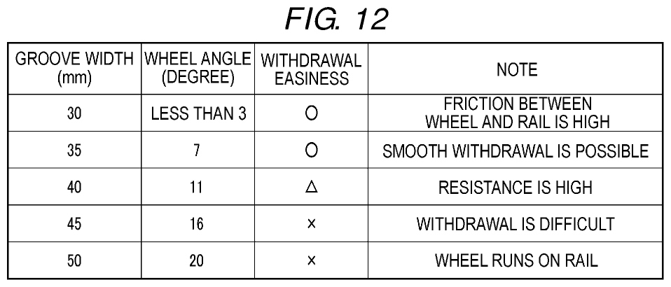

FIG. 12 is a diagram illustrating experiment results of a subjective evaluation relating to withdrawal easiness with respect to the wheel angle corresponding to the groove width and the wheel width.

The experiment results illustrated in FIG. 12 show the subjective evaluation when an examinee withdraws the cart 1 including the wheels with a wheel width b of 27 mm along the groove 72 with one of various groove widths illustrated in FIGS. 7 to 11. According to the experiment results illustrated in FIG. 12, the withdrawal easiness in the predetermined moving direction is excellent when the groove width is 30 mm or 35 mm. When the groove width is 30 mm, the examinee feels that the friction between the wheel and the guide rail 31 is large. In addition, when the groove width is 40 mm, the examinee feels that the resistance is high but the cart can be withdrawn in the predetermined moving direction. In addition, when the groove width is 45 mm or 50 mm, it is difficult to withdraw the cart in the predetermined moving direction in the evaluation.

For example, it is presumed that, according to the experiment results illustrated in FIG. 12, the groove width a of the guide rail 31 is preferably less than 40 mm with respect to the cart 1 having a wheel width b of 27 mm (the wheel angle θ is less than 10 degrees or less than 11 degrees). In addition, it is presumed that, when the withdrawal easiness of the user is important, the groove width a of the guide rail 31 is preferably 35 mm or less (7 degrees or less) with respect to the cart 1 having a wheel width b of 27 mm. In other words, according to the experiment results illustrated in FIG. 12, it can be concluded that the groove width of the guide rail 31 is preferably less than 1.5 times and more preferably 1.3 times or less the wheel width.

Next, a shape of the rails 71 that form the groove 72 for guiding the movement of the wheel 13 in the guide rail 31 will be described.

As described above, in order to smoothly guide the wheels 13 of the cart 1 to the predetermined moving direction, it is necessary appropriately set the groove width a of the guide rail 31 with respect to the wheel width b. However, in the guide rail 31, even when the wheel 13 has a groove width that allows smooth movement in the predetermined moving direction, the contact between the wheel 13 and the inner wall of the rail 71r or 71l is unavoidable. When the rotating wheel 13 collides or rubs on the inner wall of the rail 71r or 71l, the wheel 13 formed of a member of urethane, rubber, or the like may be damaged.

In the guide rail 31 according to the embodiment, the rails 71r and 71l are processed to reduce damages to the wheel 13 even when coming into contact with the wheel 13 of the cart 1. If upper end portions of the inner walls of the rails 71r and 71l are orthogonal, the wheel 13 may be largely damaged when coming into contact with the orthogonal portion. On the other hand, in the embodiment, a protective portion that reduces damages to the wheel coming into contact with the rails 71r and 71l is provided. For example, a protective portion 73 reduces damages to the wheel coming into contact with the rails 71r and 71l by processing the upper end portions of the inner walls of the rails 71r and 71l in a non-orthogonal shape.

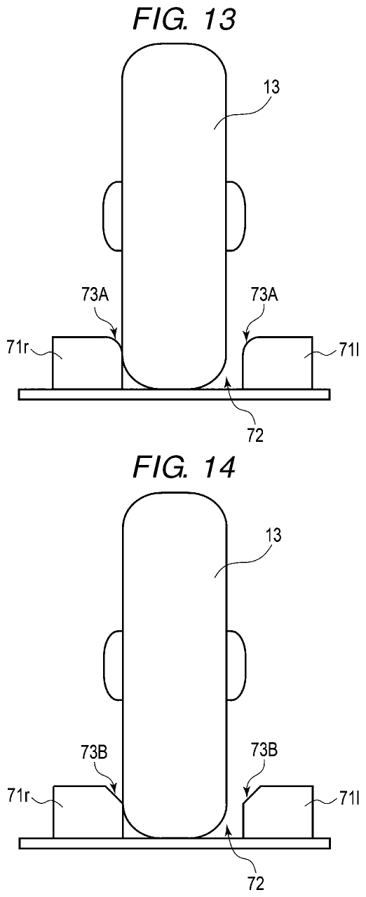

FIG. 13 is a cross-sectional view illustrating a first configuration example of the rails 71 that form the groove of the guide rail 31.

In the first configuration example illustrated in FIG. 13, the rails 71r and 71l that form the groove 72 of the guide rail 31 include a protective portion 73A that is obtained by rounding the upper end portion of the inner wall to be non-orthogonal. Even when the wheel 13 collides with the inner wall of the rail 71r or 71l in a state where the wheel 13 is inclined with respect to the predetermined moving direction, the protective portion 73A prevents a sharp force from being applied to the wheel 13. In addition, even when the side surface of the rotating wheel 13 rubs on the inner wall of the rail 71r or 71l, the protective portion 73A prevents a sharp force from being applied to the wheel 13. In the guide rail 31, the protective portion 73A is provided in the rails 71r and 71l that form the groove 72 such that damages to the wheel 13 that moves while rotating in the groove 72 can be reduced.

FIG. 14 is a cross-sectional view illustrating a second configuration example of the rails 71 that form the groove of the guide rail 31.

In the second configuration example illustrated in FIG. 14, the rails 71r and 71l that form the groove 72 of the guide rail 31 include a protective portion 73B that is obtained by obliquely cutting the upper end portion of the inner wall to be non-orthogonal. Even when the wheel 13 collides with the inner wall of the rail 71r or 71l in a state where the wheel 13 is inclined with respect to the predetermined moving direction, the protective portion 73B prevents a sharp force from being applied to the wheel 13. In addition, even when the side surface of the rotating wheel 13 rubs with the inner wall of the rail 71r or 71l, the protective portion 73B prevents a sharp force from being applied to the wheel 13. In the guide rail 31, the protective portion 73B is provided in the rails 71r and 71l that form the groove 72 such that damages to the wheel 13 that moves while rotating in the groove 72 can be reduced.

The cart is not limited to a shopping cart, but may be a picking cart used in a warehouse or the like.

Other than in the operating examples, or where otherwise indicated, all numbers, values and/or expressions referring to quantities of ingredients, properties, measurements, results, conditions, etc., used in the specification and claims are to be understood as modified in all instances by the term “about.”

With respect to any figure or numerical range for a given characteristic, a figure or a parameter from one range may be combined with another figure or a parameter from a different range for the same characteristic to generate a numerical range.

While certain embodiments have been described these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such embodiments or modifications as would fall within the scope and spirit of the invention.

What is claimed is:

1. A guide device that guides a cart to a storage position, the device comprising:
a groove configured to limit a direction in which a wheel provided in the cart moves to a predetermined moving direction such that the cart is guided to the storage position, wherein
the groove has a groove width such that a slope of the direction of the wheel in the groove with respect to the moving direction is less than a predetermined value.

2. The device according to claim 1, wherein
the groove comprises a pair of rails, and
the pair of rails are arranged such that a distance between a power receiving antenna and a power transmitting antenna is less than a predetermined distance that allows contactless power transmission, the power receiving antenna being provided on a side surface of the cart that is stored in the storage position by the wheel moving along the groove, and the power transmitting antenna being provided on a lateral side of the cart stored in the storage position.

3. The device according to claim 1, wherein
an upper end portion of an inner surface of the groove in contact with the wheel is non-orthogonal.

4. The device according to claim 1, wherein
the groove comprises a pair of rails that are parallel in a portion thereof.

5. The device according to claim 1, wherein
the predetermined moving direction is movement in substantially one dimension.

6. The device according to claim 1, wherein
the predetermined value is an angle of 20 degrees between a diameter direction of the wheel and a longitudinal direction of the groove.

7. A power supply system, comprising:
a guide device configured to guide a cart to a storage position; and
a power transmitting device, wherein
the guide device comprises
a groove configured to limit a direction in which a wheel provided in the cart moves to a predetermined moving direction such that the cart is guided to the storage position, the groove having a groove width such that a slope of the direction of the wheel with respect to the moving direction is less than a predetermined value,
the power transmitting device comprises
a power transmitting antenna that is arranged at a position at which a distance from a power receiving antenna provided in the cart that is stored in the storage position by the wheel moving along the groove is less than a predetermined distance, and
a power transmitting circuit that transmits power from the power transmitting antenna such that the power is received by the power receiving antenna provided in the cart.

8. The system according to claim 7, wherein
the groove comprises a pair of rails, and
the pair of rails are arranged such that a distance between a power receiving antenna and a power transmitting antenna is less than a predetermined distance that allows contactless power transmission, the power receiving antenna being provided on a side surface of the cart that is stored in the storage position by the wheel moving along the groove, and the power transmitting antenna being provided on a lateral side of the cart stored in the storage position.

9. The system according to claim 7, wherein
an upper end portion of an inner surface of the groove in contact with the wheel is non-orthogonal.

10. The system according to claim 7, wherein
the groove comprises a pair of rails that are parallel in a portion thereof.

11. The system according to claim 7, wherein
the predetermined moving direction is movement in substantially one dimension.

12. The system according to claim 7, wherein
the predetermined value is an angle of 20 degrees between a diameter direction of the wheel and a longitudinal direction of the groove.

13. The system according to claim 7, wherein
the predetermined value is an angle of 10 degrees between a diameter direction of the wheel and a longitudinal direction of the groove.

14. A power supply system, comprising:
a guide device configured to guide a cart to a storage position;
a power transmitting device; and
a power receiving device, wherein
the guide device comprises
a groove configured to limit a direction in which a wheel provided in the cart moves to a predetermined moving direction such that the cart is guided to the storage position, the groove having a groove width such that a slope of the direction of the wheel with respect to the moving direction is less than a predetermined value,
the power receiving device comprises
a battery that is mounted on a cart,
a power receiving antenna that is arranged on a side surface of the cart to receive power transmitted from a lateral side at the storage position, and
a power receiving circuit that supplies power received by the power receiving antenna to the battery, and
the power transmitting device comprises
a power transmitting antenna that is arranged at a position at which a distance from a power receiving antenna provided in the cart that is stored in the storage position by the wheel moving along the groove is less than a predetermined distance, and
a power transmitting circuit that transmits power from the power transmitting antenna such that the power is received by the power receiving antenna provided in the cart.

15. The system according to claim 14, wherein
the groove comprises a pair of rails, and
the pair of rails are arranged such that a distance between a power receiving antenna and a power transmitting antenna is less than a predetermined distance that allows contactless power transmission, the power receiving antenna being provided on a side surface of the cart that is stored in the storage position by the wheel moving along the groove, and the power transmitting antenna being provided on a lateral side of the cart stored in the storage position.

16. The system according to claim 14, wherein
an upper end portion of an inner surface of the groove in contact with the wheel is non-orthogonal.

17. The system according to claim 14, wherein
the groove comprises a pair of rails that are parallel in a portion thereof.

18. The system according to claim 14, wherein
the predetermined moving direction is movement in substantially one dimension.

19. The system according to claim 14, wherein
the predetermined value is an angle of 20 degrees between a diameter direction of the wheel and a longitudinal direction of the groove.

20. The system according to claim 14, wherein
the predetermined value is an angle of 10 degrees between a diameter direction of the wheel and a longitudinal direction of the groove.
